(19) United States
(12) Patent Application Publication
(10) Pub. No.: US 2007/0132574 A1
(43) Pub. Date: Jun. 14, 2007

(54) Pre-braking warning device for vehicles

(76) Inventors: Chieh-Cheng Yen, Taipei (TW); Chieh-Fu Yen, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/296,504

(22) Filed: Dec. 8, 2005

(51) Int. Cl. B60Q 1/44; G08B 21/00

(52) U.S. Cl. 340/479; 340/665

(57) ABSTRACT

A pre-braking warning device for vehicles is designed to be installed on a brake pedal of a vehicle and has a bottom substrate, a pressure-sensing unit mounted in the bottom substrate and a cover attached over the pressure-sensing unit and the bottom substrate. When the pressure-sensing unit detects that a driver's foot is placed over the brake pedal, even if the brake pedal has not been intensely and purposely stepped on, the pressure-sensing unit sends a signal to activate a pre-braking warning light to forewarn drivers behind that the car in front is about to slow down or is preparing to stop. This pre-braking warning signal can be emitted before a regular brake signal, giving other drivers more time and more braking distance to stop their cars.

### BACKGROUND OF THE INVENTION

1. Field of the Invention

The present invention relates to a pre-braking warning device for vehicles, in particular to a driving safety apparatus that is mounted on a brake pedal to detect the motion of a driver's foot and timely activates a pre-braking warning light based on the detected results.

2. Description of the Related Art

The purpose of brake lights on automobiles is to warn drivers in following cars that the car in front is slowing down or preparing to stop. However, past road accident statistics show that a conventional high-mounted central brake light is not sufficient to give drivers in following cars ample warning of the intention of the driver in the car in front to slow down or brake. In view of the fact that road conditions can change in a split second, and that the number of cars on the road and the average driving speed are both increasing, a previously defined safe following distance between two cars is becoming more difficult to determine and maintain.

In order to improve driving safety, road safety experts have done a lot of research to try to find ways to shorten the brake light response time. They have installed sensors to monitor the motion of the foot of a driver. Experts hoped that by doing so the warning time for braking could be advanced by a few microseconds, to provide drivers in following cars more time to anticipate and react to an intention to brake by a driver in front.

Under normal driving conditions, when a following driver sees the brake lights of a car in front, the driver takes about 0.2 seconds to respond and step on his/her own brake pedal. At a traveling speed of 60 mph, 0.2 seconds translates into a distance of 3.33 meters. If it is possible to eliminate that 0.2 seconds of response time, driving safety can be much improved, and perhaps many traffic accidents can be avoided.

Many different pre-braking warning devices exist on the market today and use different control circuitry and sensing devices, however, these devices focus mainly on the accelerator pedal. Most of these devices are designed to turn on the brake light as soon as the driver lifts off or releases the accelerator pedal, so as to forewarn drivers in following cars of impending deceleration and stopping by the car in front.

Many of these designs are not practical under actual driving conditions. There can be occasions when a driver might ease up on or lift off the accelerator pedal (or even take his/her foot completely off, in the case of cruise control), but it would not necessarily mean that the driver is about to step on the brake pedal. In such cases, the repeated flashing of the brake light will distract and mislead drivers in following cars. Taking the case of a vehicle with manual transmission, the driver of the vehicle usually eases off the accelerator pedal each time he/she shifts gears to get the vehicle up to speed. With the design of previous pre-braking warning devices, the brake light will be flashed repeatedly during a vehicle's acceleration process, sending wrong messages, time and again, to drivers in following cars as the car in front appears to be about to slow down or stop. Thus, unnecessary annoyance and possible danger for other car drivers may arise.

Another type of prior art uses a multi-segment brake light, where multiple light patterns are designed to represent different braking conditions. An electronic detector detects the braking condition and outputs a signal. Control circuitry receives the signal and outputs drive signals to the corresponding segments of the braking light to display a certain condition to other car drivers. Unfortunately this design creates an effect more decorative than practical because traffic and road conditions can change so rapidly that drivers do not have time to decipher the meaning behind the multiple segment signal light. When an average driver sees a brake light from a car in front, the driver will not second-guess the meaning behind the brake light but will automatically move his/her foot onto the brake pedal.

In another type of prior art, the device uses two signal lights and two control circuitries to control a driving light and a braking light. When the driver steps on the accelerator pedal, the driving light is turned on, and when his/her foot is released from the accelerator pedal, another precautionary light is turned on, and when his/her foot is placed on the brake pedal, the brake light is turned on and the driving light and the precautionary light are turned off. This type of signaling scheme resembles the changing of traffic lights.

The above-mentioned design can produce good display effects, but in reality, since one of the lights is on at any given time during driving, it would mean that drivers in following cars have to stare at the changing of the signal lights to determine a driver's real intention. If there are many cars in a heavy traffic condition, drivers in following cars will be preoccupied with the changing of the lights on the cars in front, and will not be able to concentrate on driving.

In normal situations, when a driver spots an unusual situation on the road in front, the situation might not be serious enough to require significant braking. The driver may simply release the accelerator pedal and shift his/her foot toward the brake pedal in preparation of braking, whereby such motion will enable him/her to react to any situation more quickly. However, for the cars following, the drivers are not aware of the shift of the driver's foot from the accelerator pedal to the brake pedal, as the brake light is not activated.

With reference to FIG. 7, however for most of vehicles, a switch (71) is connected to the brake pedal (72). When the driver intensively and purposely steps on the brake pedal (72), the switch (71) is triggered to activate the brake light (73). The drawback of the conventional device is that the brake light (73) is activated only when the brake pedal (72) has been obviously pressed. Therefore, a clear discrepancy in perception exists between the driver in front and the drivers in following cars. When the brake light (73) is eventually activated, there will be a delay time before the drivers behind can react to the new situation, and if the following cars do not maintain a safe distance from the car in front, a traffic accident could occur. In other words, these vehicles are not equipped with a pre-braking warning device.

In view of the discrepancy in perception between the driver in front and other drivers behind while using the above-mentioned braking systems, the inventor has developed an improved device after carrying out intensive research to improve driving safety and increase the effectiveness of the braking system.

### SUMMARY OF THE INVENTION

The main objective of the present invention is to provide a pre-braking warning device mounted on a brake pedal of a vehicle to monitor the motion of the foot of a driver, whereby a control circuit connected to the pre-braking warning device can turn on a pre-braking warning light or a regular brake light to forewarn drivers in following cars of impending braking by the front car.

To achieve the main objective, the pre-braking warning device for a vehicle is designed to be installed on a brake pedal of the vehicle and has a bottom substrate, a pressure-sensing unit mounted in the bottom substrate and a cover attached over the pressure-sensing unit and the bottom substrate. When the pressure-sensing unit detects that a driver's foot is placed over the brake pedal, even when the brake pedal has not been intensely and purposely stepped on, the pressure-sensing unit sends a signal to activate a pre-braking light to forewarn drivers behind that the car in front is about to slow down or to prepare to stop.

The features and structure of the present invention will be more clearly understood when taken in conjunction with the accompanying drawings.

### BRIEF DESCRIPTION OF THE DRAWINGS

FIG. 1 is an exploded perspective view of a pre-braking warning device for vehicles in accordance with the present invention;

FIG. 2 is a perspective view of the pre-braking warning device for vehicles of FIG. 1;

FIG. 3 is a cross-sectional view of the pre-braking warning device for vehicles along line 3-3 of FIG. 2;

FIG. 4 is an operational perspective view of the pre-braking warning device of FIG. 1 mounted on a brake pedal of a vehicle;

FIG. 5 is a circuit diagram of a control circuit of the pre-braking warning device in accordance with the present invention;

FIG. 6 is an operational perspective view of a pre-braking warning light installed at a location next to a central braking light in accordance with the present invention; and

FIG. 7 is a schematic view of a conventional braking warning device.

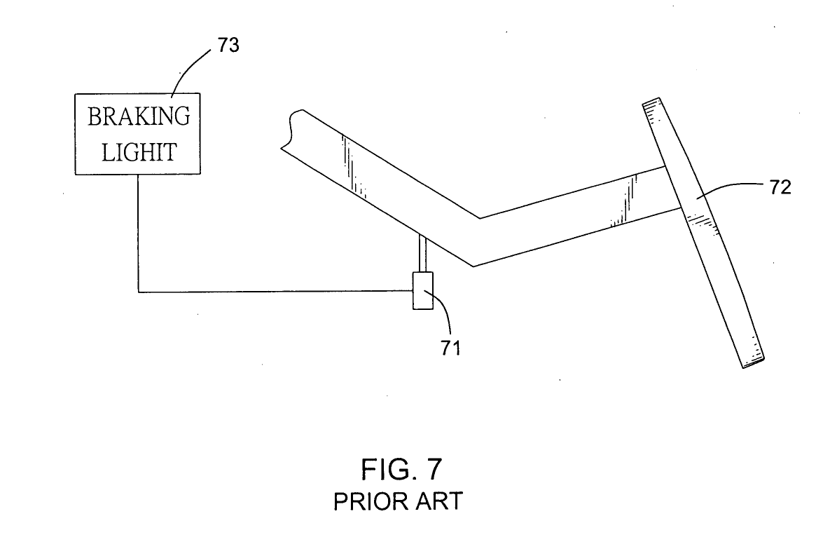

### DETAILED DESCRIPTION OF THE PREFERRED EMBODIMENT

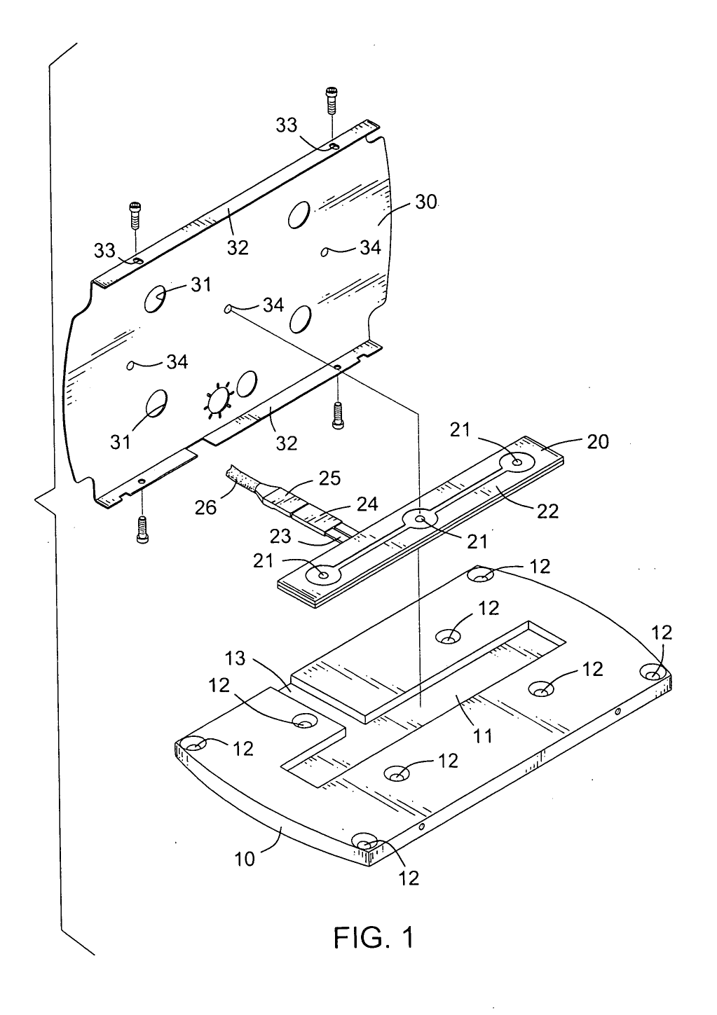

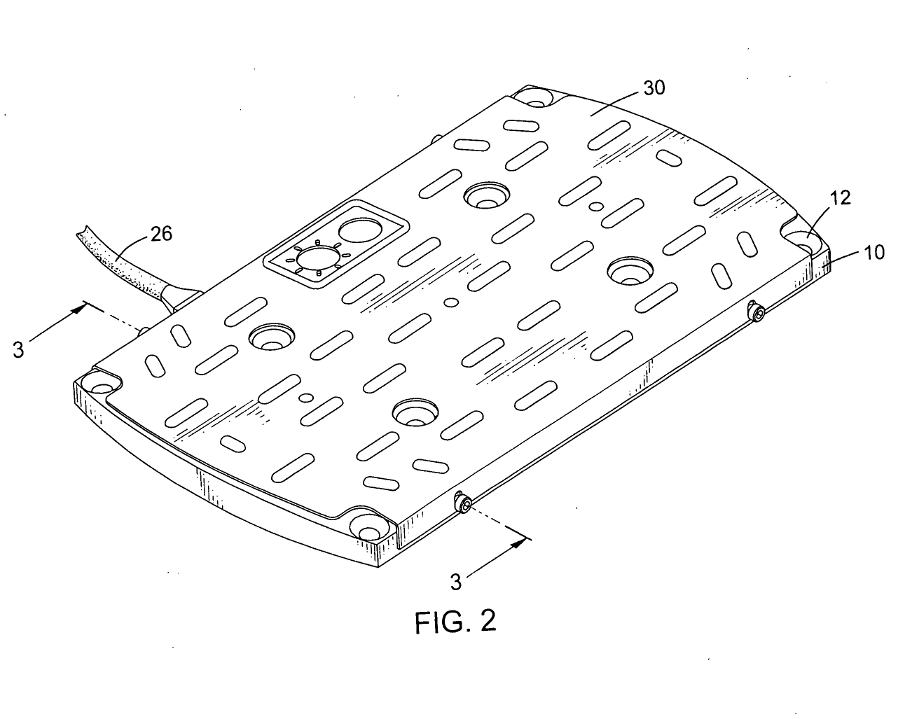

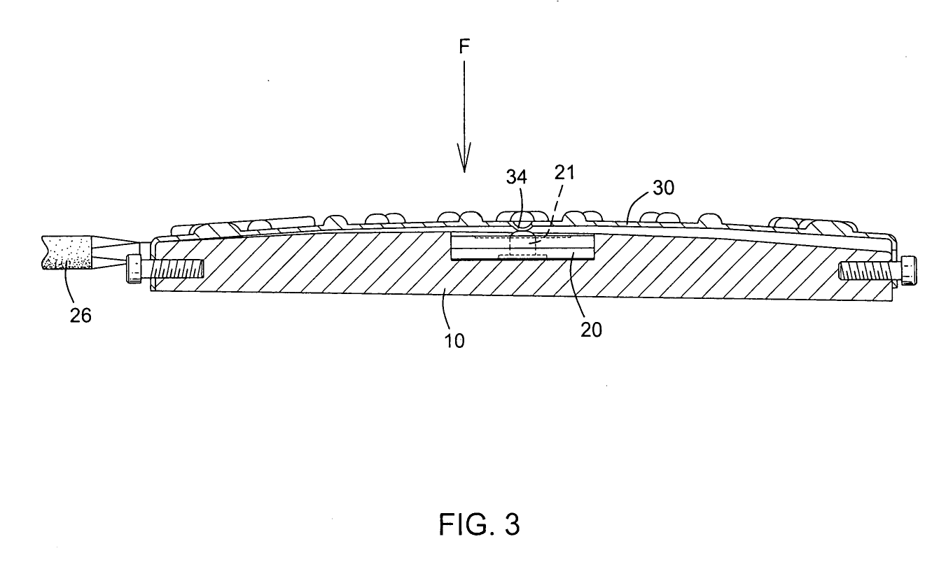

With reference to FIGS. 1, 2 and 3, a pre-braking warning device for vehicles in accordance with the present invention is able to activate a pre-braking warning light, before a regular brake light is activated, when a driver's foot moves onto a brake pedal to forewarn following cars that the car in front is slowing down or preparing to stop. The pre-braking warning device comprises a bottom substrate (10), a pressure-sensing unit (20) and a cover (30).

The bottom substrate (10) can be the already existed brake pedal in the vehicle or a separate substrate to be mounted on the brake pedal. In the following description, a separate bottom substrate is used as an example for description. The bottom substrate (10) is formed into a rectangular board with a slight convex surface and has a recess (11) defined in a center to hold the pressure-sensing unit (20). Multiple through holes (12) are defined at four corners of the bottom substrate (10) and around the recess (11). A longitudinal groove (13) communicating with the recess (11) is formed in the bottom substrate (10).

The pressure-sensing unit (20) includes multiple trigger switches (21) mounted on a thin carrier (22), wherein these trigger switches (20) are electrically connected to wires (23) to which a connector (24) is attached. The connector (24) can be a female/male connector and correspondingly linked to a matched male/female connector (25) of a cable (26). An adhesive or a double-sided adhesive tape can be applied on the bottom surface of the thin carrier (22), whereby the thin carrier (22) can be securely mounted in the recess (11). When the pressure-sensing unit (20) is placed in the recess (11), the two correspondingly linked connectors (24)(25) are held in the groove (13) of the bottom substrate (10).

The cover (30) has a shape corresponding to the bottom substrate (10) and several apertures (31) are defined to be in alignment with the through holes (12) when the cover (30) is placed over the bottom substrate (10). The cover (30) is U-shaped in cross-section. Two longitudinal flanges (32) substantially perpendicular to the surface of the cover (30) are respectively formed along opposite edges of the cover (30) to be attached to two sides of the bottom substrate (10). Fastening holes (33) are defined in the two flanges (32) so that the cover (30) can be secured to the bottom substrate (10) using fasteners, such as screws (not numbered). The cover (30) further has multiple protrusions (34) integrally formed on an inner surface, wherein each protrusion (34) is arranged in a position to trigger a respective switch (21) if any slight force, as indicated by arrow “F,” is applied on the cover (30).

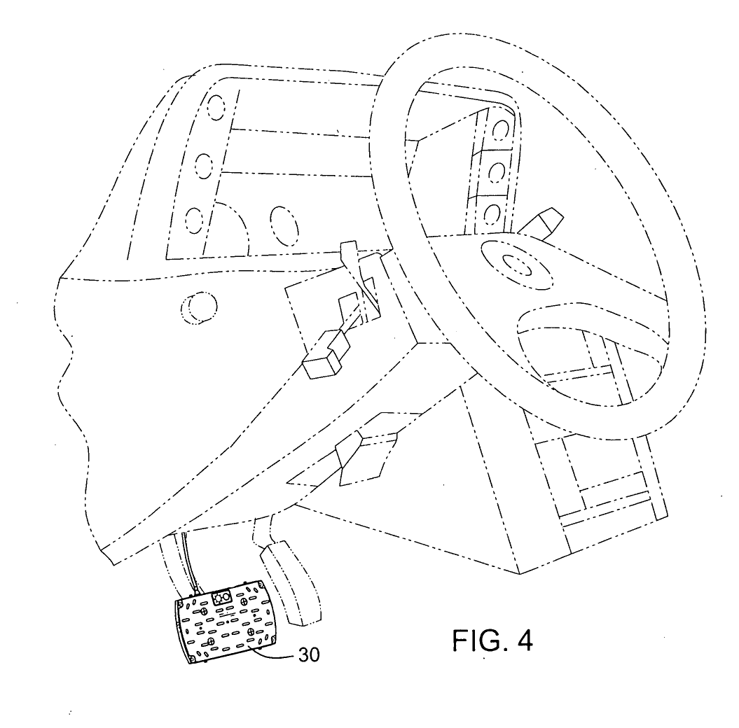

With reference to FIG. 4, when in use, the pre-braking warning device of the present invention is mounted on the brake pedal of a vehicle with screws (not numbered) passing through the through holes (31)(12). The device detects whether a driver's foot is present over the brake pedal. When the driver moves his/her foot onto the brake pedal (10), even when the brake pedal (10) has not yet been purposely stepped on, the slight pressure applied on the cover (30) is enough to activate the trigger switches (21), and cause a control circuit connected to the cable (26) to send a driving signal to activate a pre-braking warning light. The U-shaped cross-section of the cover and the convex surface of the bottom substrate (10) allow the trigger switches (21) to be more sensitive in detecting any slight pressure on the brake pedal.

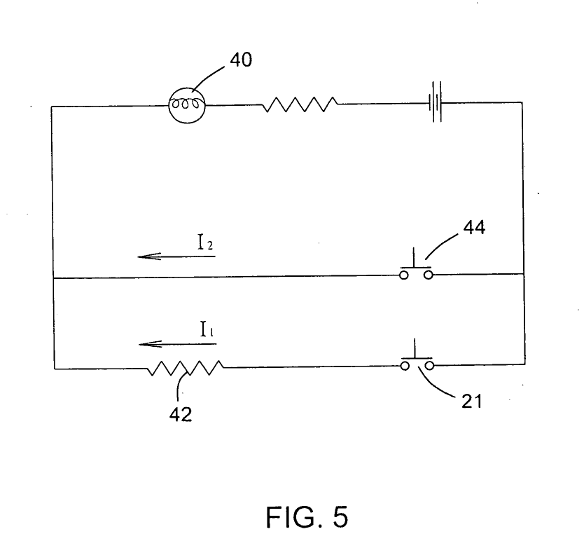

With reference to FIG. 5, the pre-braking warning is performed by the original brake light (40), such as a central high-mounted brake light of a vehicle. Different intensities of the brake light (40) can be respectively used as a pre-braking warning signal or an actual braking signal. For example, when the driver's foot is placed over but does not press on the brake pedal, only the trigger switch (21) is activated and a current (I₁) flows through a current-limiting resistor (42) and the trigger switch (21) to turn on the brake light to generate a pre-braking warning signal with lower intensity. When the brake pedal is actually stepped on, an actual brake light switch (44) is turned on to form a shortcut loop for the brake light (40). A stronger current I₂ flows through the brake light (40) to generate an actual braking signal with greater intensity.

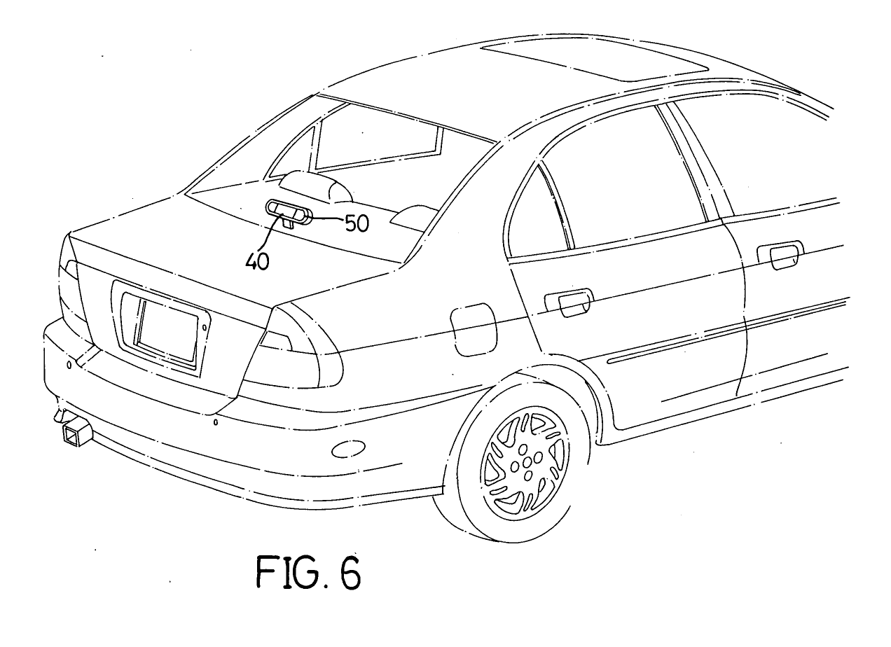

With reference to FIG. 6, a pre-braking warning light (50) can be a separate lighting device installed next to a brake light (40) on the vehicle. When the driver's foot is placed on the brake pedal, the trigger switch (21) is activated and causes the pre-braking warning light (50) to be turned on to forewarn drivers behind of impending braking by the car in front. When the driver steps on the brake pedal, the brake light (40) is turned on and the pre-braking warning light (50) is switched off.

From the foregoing, the pre-braking warning device of the present invention can be installed on a brake pedal to detect a driver's action. In the case where the driver's foot is placed over the brake pedal, the pre-braking warning light is automatically turned on to forewarn the drivers in following cars of the impending braking. Therefore, the drivers in following cars can have more time to prepare for the braking by the driver in front, thus the risk of crashing into the rear of the front car is largely reduced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pre-braking warning device for vehicles, the device comprising:
a bottom substrate;
a pressure-sensing unit mounted in the bottom substrate;
a cover mounted over the pressure-sensing unit and the bottom substrate;
wherein when the pressure-sensing unit detects that a driver's foot is placed over the brake pedal, the pressure-sensing unit sends a signal to activate a pre-braking warning light to forewarn drivers in following cars of impending braking.

2. The pre-braking warning device as claimed in claim 1, wherein the pressure-sensing unit comprises a carrier on which multiple trigger switches are mounted.

3. The pre-braking warning device as claimed in claim 2, wherein the bottom substrate is a separate bottom substrate to be mounted on a brake pedal.

4. The pre-braking warning device as claimed in claim 2, wherein the bottom substrate is a brake pedal.

5. The pre-braking warning device as claimed in claim 3, wherein a recess is defined in the bottom substrate to hold the pressure-sensing unit.

6. The pre-braking warning device as claimed in claim 4, wherein a recess is defined in the bottom substrate to hold the pressure-sensing unit.

7. The pre-braking warning device as claimed in claim 5, the cover having an inner surface on which multiple protrusions are integrally formed, wherein each protrusion corresponds to a respective trigger switch of the pressure-sensing unit.

8. The pre-braking warning device as claimed in claim 6, the cover having an inner surface on which multiple protrusions are integrally formed, wherein each protrusion corresponds to a respective trigger switch of the pressure-sensing unit.

9. The pre-braking warning device as claimed in claim 7, wherein the bottom substrate and the cover have multiple through holes that allow the pre-braking warning device to be mounted on a brake pedal.

10. The pre-braking warning device as claimed in claim 8, wherein the bottom substrate and the cover have multiple through holes that allow the pre-braking warning device to be mounted on a brake pedal.

11. The pre-braking warning device as claimed in claim 9, wherein the bottom substrate has a convex top surface and the cover has a U-shaped cross-section to allow the trigger switches to be more sensitive in detecting any slight pressure on the brake pedal.

12. The pre-braking warning device as claimed in claim 10, wherein the bottom substrate has a convex top surface and the cover has a U-shaped cross-section to allow the trigger switches to be more sensitive in detecting any slight pressure on the brake pedal.

13. The pre-braking warning device as claimed in claim 11, wherein the pre-braking warning signal is implemented by an original high-mounted central brake light.

14. The pre-braking warning device as claimed in claim 12, wherein the pre-braking warning signal is implemented by an original high-mounted central brake light.

15. The pre-braking warning device as claimed in claim 11, wherein the pre-braking warning light is an individual light installed near an original brake light.

16. The pre-braking warning device as claimed in claim 12, wherein the pre-braking warning light is an individual light installed near an original brake light.

17. The pre-braking warning device as claimed in claim 13, the pre-breaking warning light is a red, yellow or a conspicuous color light.

18. The pre-braking warning device as claimed in claim 14, the pre-breaking warning light is a red, yellow or a conspicuous color light.

19. The pre-braking warning device as claimed in claim 15, the pre-breaking warning light is a red, yellow or a conspicuous color light.

20. The pre-braking warning device as claimed in claim 16, the pre-breaking warning light is a red, yellow or a conspicuous color light.
